(19) United States
(12) Patent Application Publication
(10) Pub. No.: US 2008/0040266 A1
(43) Pub. Date: Feb. 14, 2008

(54) Method of distributing funds

(76) Inventors: Douglas Harrison, Keller, TX (US); Brad Meyer, Colleyville, TX (US)

Correspondence Address: Thrasher Associates, LLC, 391 Sandhill Dr., Richardson, TX, 75080, US

(21) Appl. No.: 11/503,832

(22) Filed: Aug. 14, 2006

(51) Int. Cl. G06Q 40/00

(52) U.S. Cl. 705/40

(57) ABSTRACT

A method of distributing funds to complete a project, including construction financing where funds are distributed at multiple times. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The present invention relates generally to distributing loan funds as draws.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Many forms of financing, including many loan types, are disbursed in two or more transactions, each called a “draw.” For ease of reading, in this patent application financial transactions are referred to collectively as “loan(s).” A draw is simply a withdrawal of some portion of the total loan amount, and may also be called a “tranche” or other term. It is appreciated in the financial arts that the actual term used for a draw is often industry or loan-type dependent. Draws are particularly common where a loan's funds are being used to fund construction, manufacturing, and other projects that take many days to complete, and have identifiable and trackable value-added milestones. For example, one may examine construction spending. Draws are used in construction spending and projects because the construction of homes, commercial structures, and the like may take many days and even many months. Draws benefit the lender by reducing risk exposure, and benefit the borrower by not having to pay interest on funds that would otherwise just “sit” in an account. Typically, after an on-sight physical verification of progress a lender authorizes the borrower to make a draw. However, this process has several drawbacks.

For example, if a loan allows draws based on milestones or benchmarks, there may be a delay between when that milestone/phase is completed and the approval of the next disbursement. If a loan allows a draw based on a particular point in time, there may be a gap in time between the completion of the phase and the disbursement, or alternatively, more money may be released before the phase is completed. In both cases risks associated with construction are transferred from one party to the other in ways disadvantageous to the parties. Thus, a borrower may not have an incentive to move more rapidly to the completion of a construction project. Additionally, the lender does not realize the full value of interest, or, alternatively, the borrower incurs unnecessary interest expenses. Accordingly, there is a need for a system and method that more quickly and efficiently allows borrowers to access the right amount of funds at the right time.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 (prior art) is a graphical representation of total-cash draws made over time as well as construction progress, where time is represented along the horizontal axis and the vertical axis represents a percentage as a function of time.

FIG. 2 illustrates a method according to the invention, here called a reallocation algorithm.

FIG. 3 is a logic flow diagram, referred to as a draw reallocation algorithm.

FIG. 4 is a graphical representation of an exemplary construction project financing incorporating the methodology of the draw reallocation algorithm.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### DESCRIPTION OF THE DRAWINGS

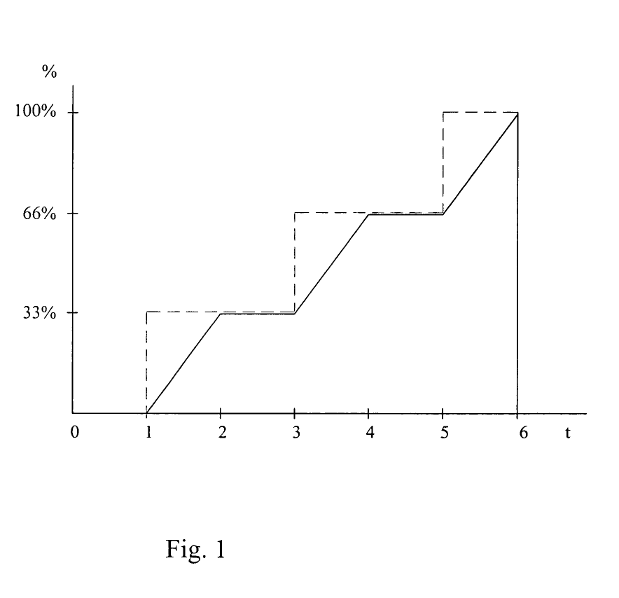

FIG. 1 (prior art) is a graphical representation of total-cash draws made over time as well as construction progress, where time is represented along the horizontal axis and the vertical axis represents a percentage as a function of time. It should be pointed out that for the example shown, the construction line of FIG. 1 assumes that construction begins simultaneously with the first draw. However, it is understood that construction more often begins some time before the first draw is made, and lenders typically view each draw as a reimbursement for work completed. FIG. 1 illustrates both a financing line (comprising dashes) and a solid construction progress line. Referring to the construction line, at time t=0 a loan is approved. At time t=1 the first draw is made and construction begins, and continues as long as construction funds are available. This progress is illustrated linearly as the upward sloping portion of the construction progress line. At time t=2 funds are expended, thus stalling construction progress until additional funding is available. Often, additional funding is not available until some delay in construction progress because lenders want “proof” of acceptable progress, which is typically made through an inspection. At some point between t=2 and t=3 the inspection is completed, a favorable report generated, and the lender completes the paperwork required for the next draw. Thus, at time t=3 a second draw is approved and construction progress begins again (illustrated as the upward sloping portion of the construction progress line) and continues until funds are once again exhausted at time t=4. As was the case at time t−2, construction is again stalled until additional funding is available, typically after an additional inspection. Following a process similar to that already discussed, at time t=5 another draw is made and construction resumes until it is completed, shown as occurring at time t=6.

Similarly, the funding line is illustrated as the dashed line of FIG. 1. Due to the nature of discrete draws, it appears in FIG. 1 as a stair-step pattern. At time t=1 a first draw is provided comprising 33% of the approved loan total. As noted above, no further funding is provided until an inspection is passed and the paperwork is completed. Accordingly, the second draw is made at time t=3 for an additional 33% of the approved loan total. No further funding is provided until a request for an inspection is made around time t=4, and the appraisal is received and the paperwork is completed such that at time t=5 a new draw is made for the remaining approved loan balance. Here, the funding is shown as being adequate to complete the construction project.

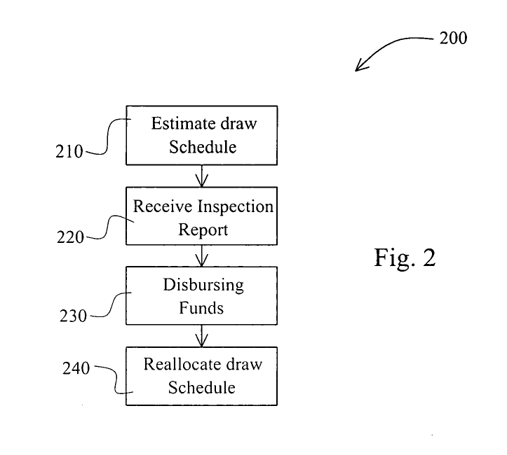

FIG. 2 illustrates a method according to the invention, here called a reallocation algorithm 200. FIG. 2 is discussed without reference to a particular graph to emphasize that the invention is a process, and not a particular graph or graphical representation (although various aspects of the invention may be represented graphically). The reallocation algorithm 200 begins with an estimate draw schedule act 210. A draw schedule comprises the estimated times of draws and the estimated amounts of those draws. By building a draw schedule a lender can anticipate future inspections and better manage those inspections. Graphically, it could appear like the funding line of FIG. 1, however, it should be understood that a graphical representation of a draw schedule may be represented as a curved line, broken line, and the like depending on the information conveyed by the respective graphical representation. Accordingly, the estimate draw schedule act 210 estimates how much each draw will be and when each draw will occur. The reallocation algorithm 200 next proceeds to a receive inspection report act 220 in which an inspection report is received. It is appreciated that the inspection report may be based on any known, unknown, foreseeable or unforeseeable inspection methodology, including on-site physical inspections, on-site camera inspections (including photos and live video), or satellite inspection, for example. Furthermore, it is appreciated upon reading this disclosure that the inspection may be initiated by either party at any point in time (while some inspections are scheduled by the lender beforehand and are made according to this schedule absent some outside interference, it is present practice to generate an inspection upon a request of one of the parties). Of course, should the inspection indicate that less than the predicted progress has been made, then additional work is performed until an inspection indicates that sufficient progress has been made. Then, in a disburse funds act 230, the appropriate funds are transferred or otherwise turned over to the borrower.

The results of an inspection are not always predictable. For example, a draw may be scheduled based on an assumption that the work at that time will be 50% complete, and that the lender will provide the borrower with 50% of the project's available funds at that time. However, the borrower may have arranged for the completion of a larger portion of the project at that time, and may want access to funds that reflect the additional progress. For example, if the project at the time of the draw is not just 50% complete, but actually 75% complete, the borrower may want access to up to 75% of the project's available funds. Likewise, the lender may be willing to provide more than 50% of the available funds to both encourage quicker project completion (which may reduce project risk) as well as to begin earning interest on those funds more quickly. Accordingly, in a reallocate draw schedule act 240, the lender overrides the draw schedule and allows the borrow to receive more than 50% of the funds. The lender need not allow access to 75% of the available funds, and in some cases, may actually allow access to more than 75% of the available funds.

This decision affects the available draw at each of the remaining draws. Accordingly the lender reallocates the amount available for each of the remaining draws. Furthermore, the estimated construction schedule will likely also change. Each of these changes can be encompassed in the reallocate draw schedule act 240. Furthermore, the reallocations may be made linearly, based on regression, interpolation, or may depend on a lender preferences, such as the nature of the project, a particular phase of project completion, and/or past experience with the borrower, for example.

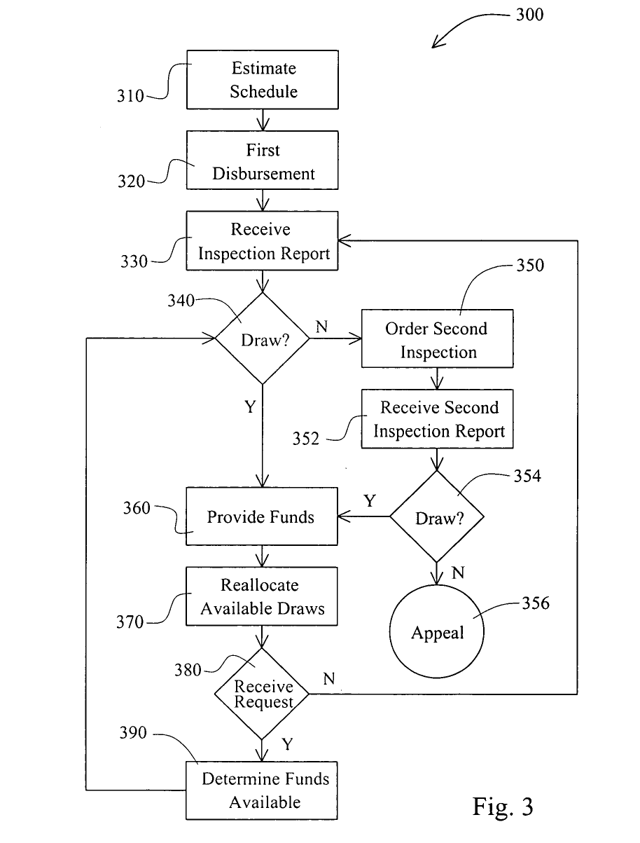

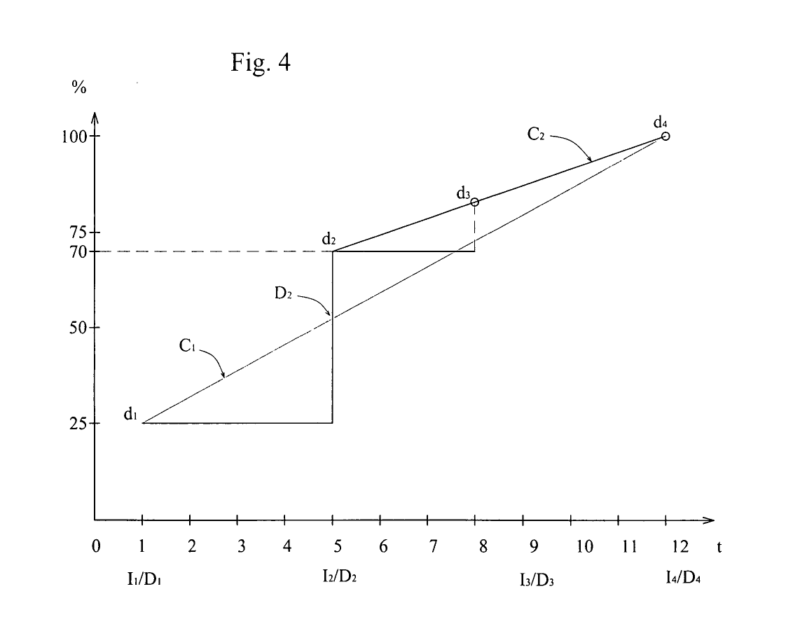

The following discussion makes simultaneous reference to FIG. 3 and FIG. 4. FIG. 3 is a logic flow diagram, referred to as a draw reallocation algorithm 300. Likewise, FIG. 4 is a graphical representation of an exemplary construction project financing incorporating the methodology of the draw reallocation algorithm 300. In FIG. 4 time is represented on the horizontal axis, and the vertical axis represents some percentage. Estimated construction progress lines C1 and C2 illustrate projected (estimated) construction progress, as discussed below, and project funding is illustrated as a stair-step function. The example of FIG. 4 is based on construction lending, and, thus, from time to time the present discussion makes reference to various events in terms of construction progress, lending, and funding. However, the invention is in no way limited to construction funding and has applicability to any financing that incorporates draws.

The algorithm 300 begins with an estimate draw schedule act 310. A draw schedule may be milestone based, time based, project portion based, borrower dependent, or based on any other methodology known, unknown, foreseeable or unforeseeable. In FIG. 4 a plan for four draws, D1-D4, is shown. It is appreciated that various data is desirable for accurately estimating the amount and timing of draws; in construction, it is often desired that one knows: the closing date of financing, the construction term, the date of completion, the value of the property, the construction cost, the expected number of draws, the expected number of days/weeks/months/years of the construction, construction milestones, the amount of funding requested, and the % of construction expected or estimated to be completed at a particular point in time, for example. Lending for other project types may require or desire other data.

Although not illustrated graphically as a line in FIG. 4, the draw schedule estimated in the estimate draw schedule act provides 25% of the available funds for the project at each of four draws, indicated as: draw 1=D1 at time t=1, draw 2=D2 at time t=5, draw 3=D3 at time t=9, and draw 4=D4 at time t=12. Accordingly, in this example, one observes that the borrower is not expected to receive all the available funds until the project is 100% complete. Here, the estimated construction progress line C1 appears to track the estimated draw schedule, however, this is due to the linear nature of the estimated construction progress and the estimated draw schedule. And, although there is typically some relationship between the estimated construction progress line and the estimated draw schedule, the two are not necessarily identical. Furthermore, although the estimated construction progress line C1 is illustrated in FIG. 4 as a straight line, in practice the line may be irregularly shaped and have inflections. The draw schedule is accordingly created such that the first draw reimburses and pays the borrower for completing 25% of the project. Thus, here, it is up to the borrower to “float” or otherwise manage expenses until the first draw is received, and to likewise manage financing to complete 50% of the project, at which time 50% of the funds are available for disbursement, to complete 75% of the project at which time 75% of the funds are available for disbursement, and to complete the project at which time the borrow may access the remaining available funds.

In this example, one may note that in contrast with the example of FIG. 1, the funds are generally disbursed as or after value is added to the project, however, this is merely demonstrating a loan type and is not limiting to the invention.

Optionally, in the estimate draw schedule act 310, the algorithm 300 may schedule inspections estimated to be needed to timely allow for the draws D-D4. Here, the first inspection I1 is scheduled just prior to time t=1. Such an inspection may be scheduled because it is estimated that 25% of the project is completed (or, that 25% of the project's value is realized) at time t=1. This may occur in construction, for example, where a foundation is prepared, leveled, poured, set, and inspected by the appropriate authorities. Similarly, inspection I2 is scheduled just prior to time t=2. Although scheduling an inspection for the week before a scheduled draw is preferred, and scheduling an inspection four days before or the day before a draw are alternatives, it appreciated that inspection schedules, while built around draw schedules, are not necessarily scheduled at any particular time prior to the draw. In one embodiment, a first disbursement is received automatically, either by contract, based on the above estimates, or otherwise, in a first disbursement act 320. Thus, the first draw D1 may be dependent on or independent of a successful first inspection I1. Here, it is shown as being dependent on the first inspection I1.

Accordingly, the algorithm 300 proceeds to a receive inspection report act 330. The receive inspection report act 330 may result either from a scheduled inspection or from an independently requested inspection. For purposes of the present example, it is assumed that the inspection report is generated at I1. FIG. 4 shows that the inspection report indicates that the borrower is entitled to receive all 25% of the funds available from the estimated draw D1, resulting in the actual draw d1. Accordingly, the algorithm 300 proceeds to a draw query 340, in which the borrower indicates if he wants to draw all or a portion of the funds immediately available. If he does, the algorithm 300 proceeds through the yes “Y” decision, and the algorithm 300 proceeds to a provide funds act 360 in which the borrower may withdraw, direct, or otherwise transfer any portion of or all of the funds identified as being available. However, if the borrower disputes the results of the inspection report, he may refuse any portion or all of the available funds, the decision of which is shown by the no “N” decision line, and a second inspection is ordered in an order second inspection act 350. Thus, the second (and unscheduled) inspection is made at the request of the borrower, which in practice typically occurs when the borrower thinks that the results of the scheduled inspection were in some way flawed. However, it is appreciated that a second inspection may be requested for any reason, such as a finding of some alleged deficiency, insurance, or audit, for example.

Following the request for the second inspection, the second inspection report will be received by the algorithm 300 in a receive second inspection report act 352. Accordingly, the borrower may, in a second draw query 354, accept the draw available based on the findings of either of the first inspection I1 or the requested unscheduled inspection. Alternatively, the offered draw may be based on the use of either inspection, or the averaging or other mixing of the two inspections, subject to decision rules implemented by contract or policy. A decision to accept all of or a portion of the draw offered in the second draw query 354 is shown by the yes “Y” decision, and accordingly, the algorithm 300 proceeds to the provide funds act 360. Alternatively, the borrower may reject the findings of the second inspection as shown by the no “N” decision and appeal or otherwise challenge any of the inspection findings in an appeal act 356.

A re-allocate available draws act 370 not only accounts for deviations in funding disbursed, it also re-calibrates the estimated construction progress schedule (graphically illustrated as the estimated construction progress line C1). In the present example, it is illustrated that the borrower took a draw d1 of all the available funds, being 25% of the total amount of funding at time t=1. Because draws were just scheduled and because the 25% accepted was equal to the amount allocated for draw 1 D1, no adjustment in the estimated construction progress line C1 is made in the re-allocate available draws act 370. The algorithm next proceeds to a receive request query 380 in which the algorithm readies itself to receive a request of funds from the borrow prior to the next scheduled inspection. If none is received as shown by the no “N” decision, then the algorithm 300 returns to the receive inspection report act 330 in which the next scheduled inspection report (here, I2) is received. However, if a request for additional funds is received prior to the next scheduled inspection, as shown by the yes “Y” decision, then the algorithm proceeds to a determine funds available act 390, discussed below, before returning to the draw query 340.

Provided that no request for a draw is received in the receive request query 380, the next scheduled draw D2 should occur at time t=5, and should provide the borrower 50% of the total available funds for the project. This is based on the second inspection report I2 (received in the receive inspection report act 330) demonstrating that the borrower has progressed at least 50% of the way through the project. Accordingly, the algorithm 300 has returned to the receive inspection report act 330.

From FIG. 4, it is seen that the second inspection I2 report, at time t=5, reveals that the construction has progressed more than 50%. Instead, approximately 70% of the projected construction is complete. In other words, 20% more progress (40% more than estimated for this time) has been completed. Accordingly, the lender chooses to make an additional 20% of the total available funds immediately available to the borrower. Here, the second draw d2 demonstrates that the borrower accepts the available funds, which are provided in the provide funds act 360. Because the funds provided exceed the draw schedule, the algorithm 300 next re-allocates future draws in the re-allocate available draws act 370 and generates a second estimated construction progress line C2 to take the present (time t=5) construction progress into account. Likewise, as is the case with the initial funds allocation, draw schedule, and construction schedule, the lender now re-allocates the funds available for the present draw (d2) and extrapolates data for future draws (D3, now about 80% of total available funds or in other words 10% more of the total available funds, and D4, which is pegged to 100% of total available funds, or in other words a 20% distribution of total available funds). Of course, in addition to the amounts of the draws being changed, the scheduling (timing) of the draws may also be changed.

As construction progress continues, then the next draw D3 of approximately 80% of available funds is expected to occur at time t=9. However, from FIG. 4 it is shown that the borrower chooses to request a withdrawal of funds prior to the next scheduled draw D3, specifically at time t=8. This corresponds to a yes “Y” decision in the receive request inquiry 380.

Because the borrower has now requested a draw of funds at an unscheduled draw time, t=8, the algorithm 300 continues to the determine funds available act 390. In the determine funds available act 390 an interpolation (here, a linear interpolation) is made. Here, the algorithm 300 estimates the present valuation of the project by basing the rate of funding on the estimated construction progress. To do this, the present time t=8 is used to find a point on the estimated construction progress line C2. The point on the estimated construction progress line C2 indicates that a draw d3 is available for 75% of the total available funds, or in other words, an additional 5% of the total available funds. These funds are immediately available (meaning that they are available in hours, minutes or seconds, rather than in days).

This funding decision requires no actual physical inspection, and, in most cases, requires no inspection of any type. Because the draw d3 is being made following a known inspection at time t=5, and just prior to another inspection at time t=9, the lender decides that the risk associated with the unscheduled draw is acceptable as part of the determine funds available act 390. The borrower then, in the draw funds act 340, elects to draw the available 5% of total available funds. Accordingly, in the provide funds act 360, draw d3 is allocated and distributed to the borrower. The dashed lines in FIG. 4 at time t=8 represent the decision of the borrower to accept the draw. Notice that this does not affect the estimated construction progress line C2, but does affect the amount of funds available for the third scheduled draw D3, and these facts are accounted for in the re-allocate available draws act 370 by reducing the allocation of funds available at draw D3 from 10% to 5% of total available funds.

If the borrower does not request another unscheduled draw in the receive request query 380, at time t=9 the algorithm 300 proceeds to the order second inspection act 350. In the present example, the third inspection I3 determines that construction progress is in line with the estimated construction progress line C2, meaning that approximately 80% of the project is completed, and an additional 5% of the total available funds are now immediately available as a draw. However, the borrower decides that he has sufficient funds available to complete the project and does not accept the draw, and so no draw of funds is made in the draw query 340. Even though no funds are drawn, because the borrower does not contest the inspection results the algorithm proceeds to the provide funds act 360 in which case zero funds are provided to the borrower. In the re-allocate available draws act 370, because construction is on schedule, no new estimated construction progress line is drawn. However, because additional funds are available, the re-allocate available draws act 370 does re-allocate the now available 5% of total available funds to draw 4 (D4), to increase the amount at draw 4 from 20% to 25% of total available funds.

The borrower does not make an additional unscheduled draw request. Accordingly, the algorithm 300 proceeds from the receive request query 380 to receive the fourth inspection report I4 in the receive inspection report act 330. Here it is shown that project is completed (also shown as 100%), and that all of the total available funds (100%) are available for draw. Accordingly, in the draw query 340, the borrower chooses to accept the remaining funds, which are distributed to the borrower in the provide funds act 360 as d4. Accordingly, the algorithm 300 ends when total funds allocated in the draws d1-d4 is 100%.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method of distributing funds to complete a project, comprising sequentially:
estimating a schedule of a plurality of draws for withdrawing funds from an account;
each draw having an estimated draw time and an estimated draw amount, the group of estimated draw times defining an estimated draw schedule;
each draw amount being a function of an estimated progress of the project at the corresponding estimated draw time;
allocating a plurality of inspections, each inspection of the plurality of inspections corresponding to an estimated amount of the project that has been completed to define an inspection schedule;
receiving an inspection report generated from an inspection, the inspection report comprising information indicating the amount of progress made toward completing the project;
determining funds immediately available for disbursement based on the amount of progress made toward completing the project;
re-allocating [extrapolating] the amount of each draw for each remaining estimated draw time based on the amount of progress remaining to be made to complete the project;
receiving a request for at least a portion of a next draw prior to the next draw time, the request comprising a request draw time and a request draw amount; and
determining funds immediately available for disbursement at the request draw time by interpolating the funds immediately available following the last actual draw, and the funds expected to be available at the next draw time, as a function of the request draw time.

2. The method of claim 1 wherein a plot of total funds withdrawn as a function of time defines a build curve.

3. The method of claim 1 wherein a the inspection report is based on an on-site physical inspection.

4. The method of claim 1 wherein a the inspection report is based on an on-site camera inspection.

5. The method of claim 1 wherein a the inspection report is based on a satellite image inspection.

6. The method of claim 1 wherein the inspection is initiated by the borrower so that funds may be issued prior to any of the draw times.

7. The method of claim 1 wherein an amount of a draw is equal to the amount of the project that is complete, the amount being expressible as a percentage.

8. The method of claim 1 further comprising an inspection initiated by the borrower.

9. The method of claim 1 further comprising distributing at least a portion of the funds determined to be immediately available at the request draw time.

10. The method of claim 1 further comprising distributing at least a portion of the funds determined to be immediately available at the request draw time without performing an inspection.

11. The method of claim 1 further comprising:
receiving a request for an intermediate inspection;
receiving an intermediate inspection report generated from an inspection, the intermediate inspection report comprising information indicating the amount of progress made toward completing the project;
determining funds immediately available for disbursement based on the amount of progress made toward completing the project; and
re-allocating [extrapolating] the amount of each draw for each remaining estimated draw time based on the amount of progress remaining to be made to complete the project.

12. The method of claim 11 further comprising distributing at least a portion of the funds determined to be immediately available.

13. The method of claim 1 further comprising calculating a velocity change point, the velocity change point being a function of the number of days between inspections, divided by the number of days in a term [such as a week].
